(19) United States
(12) Patent Application Publication
(10) Pub. No.: US 2021/0003250 A1
(43) Pub. Date: Jan. 7, 2021

(54) FILTER ELEMENT FOR FILTERING A FLUID FLOW

(71) Applicant: Filtration Group GmbH, Oehringen (DE)

(72) Inventors: Gernot Hesse, Oehringen (DE); Wilhelm Schoepp, Altlussheim (DE)

(21) Appl. No.: 16/969,556

(22) PCT Filed: Feb. 8, 2019
(86) PCT No.: PCT/EP2019/053090

§ 371 Date: Aug. 12, 2020

(30) Foreign Application Priority Data
Feb. 13, 2018 (DE) 102018202178.3

(51) Int. Cl. F16N 39/06; B01D 29/15; B01D 35/147

(52) U.S. Cl. CPC F16N 39/06; B01D 29/58; B01D 35/147; B01D 29/15

(57) ABSTRACT

A filter element for filtering a fluid flow, e.g., lubricating oil, is disclosed. The filter element includes a cylindrical fine filter body that forms a fine filter stage, a cylindrical main filter body that forms a main filter stage, and a cylindrical protection filter body that forms a protection filter stage. The fine filter body and the main filter body follow one another axially and enclose a cavity so that the fine filter stage and the main filter stage are arranged fluidically parallel. The protection filter body is arranged in the cavity so that the protection filter stage is fluidically arranged downstream of the fine filter stage and the main filter stage. A bypass valve is disposed on a first end plate for bypassing the fine filter stage and the main filter stage. An intermediate plate axially connects the fine filter body to the main filter body.

### CROSS-REFERENCE TO RELATED APPLICATIONS

This application claims priority to International Patent Application No. PCT/EP2019/053090, filed on Feb. 8, 2019, and German Patent Application No. DE 10 2018 202 178.3, filed on Feb. 13, 2018, the contents of both of which are hereby incorporated by reference in their entirety.

### TECHNICAL FIELD

The present invention relates to a filter element for filtering a fluid flow. The invention additionally relates to a filter device having such a filter element.

### BACKGROUND

When a fluid flows through a filter element, this results in a pressure drop of the fluid flow on the filter element. The lower the filter fineness of a filter body is, the higher is the pressure drop of the fluid flow on the filter body. In order to avoid too high an undesirable pressure drop a filter element can comprise multiple filter bodies each with a different filter fineness, through which different filter stages are formed. A filter element, furthermore, can comprise at least one bypass valve for bypassing one bypass valve for bypassing one or more filter stages. The pressure drop on the filter element or which filter stages are flowed through by the fluid flow is dependent on the viscosity of the fluid flow, wherein the viscosity of the fluid flow is dependent on the temperature of the fluid flow. The filter fineness of the respective filter body and the at least one bypass valve can be designed so that dependent on the temperature or the viscosity of the fluid flow, different filter bodies are flowed through, as a result of which different degrees of cleanliness of the filtered fluid flow are achieved.

The filter element can be arranged in a filter housing with a cover and comprise fixing lugs which grasp the cover when the cover is arranged on the filter housing and the filter housing is in the closed state, as a result of which the filter element is centred centrally in the filter housing, even when the filter housing is in an inclined installation position. Disadvantageous is that the fixing lugs engage in the cover only when the filter housing is in the closed state. When the cover is detached from the filter housing, for example while changing the filter element, the filter element is no longer centred concentrically in the filter housing. With detached cover, the filter element lies against the inner walls of the filter housing as a result of which changing the filter element is rendered more difficult. It is disadvantageous, furthermore, that water and oil ageing products are only inadequately separated by the filter element.

### SUMMARY

The present invention therefore deals with the problem of stating an improved or at least alternative embodiment for a filter element which in particular prevents that the filter element, while changing the filter element, lies against the filter housing and by way of which it is made possible to separate water and oil ageing products from the fluid flow during the filtering of the fluid flow.

The present invention therefore deals with the problem of stating an improved or at least alternative embodiment for a filter element, through which an improvement of the filtration performance of the filter element is made possible.

According to the invention, this problem is solved through the subject of the independent claim(s). Advantageous embodiments are subject of the dependent claims.

The present invention is based on the general idea of providing a filter element designed cylindrically and in three stages for filtering a fluid flow, in particular for filtering lubricating oil, having a cylindrical fine filter body, which forms a fine filter stage, a cylindrical main filter body, which forms a main filter stage, and a cylindrical protection filter body, which forms a protection filter stage, and having a first end plate, on which at least one bypass valve for bypassing the fine filter stage and the main filter stage is formed, and having an intermediate plate, which axially connects the fine filter body to the main filter body, wherein the fine filter body and the main filter body axially follow one another and enclose a cavity of the filter element, so that the fine filter stage and the main filter stage are arranged fluidically parallel, and wherein the protection filter body is arranged in the said cavity, so that the protection filter stage is arranged downstream of the fine filter stage and the main filter stage, in which according to a first solution according to the invention on the intermediate plate at least two radially projecting spacer elements spaced apart from one another in the circumferential direction and distributed over the circumference of the intermediate plate are formed, by which the filter element during the changing of the filter element is supported on the filter housing. This is advantageous since by way of this a change of the filter element is facilitated. By way of the spacer elements, the filter element is centred concentrically in the filter housing. This is advantageous since by way of this a uniform filtration of the fluid flow is made possible. Practically, the spacer elements are embodied so that the spacer elements represent as low as possible a flow resistance for the fluid flow flowing through the filter element. While flowing through the filter element, the fluid flow is freed of contaminations, wherein on the main filter body and the protection filter body the greater part and on the fine filter body the smaller part of the fluid flow is filtered. In the process, the fluid flow flows through the filter element from the outside to the inside. With the oil in the cold state, for example when starting a wind energy plant, the oil has a high viscosity. Because of this, the main filter stage and the fine filter stage can only be flowed through by a very small part of the fluid flow. Because of this, the pressure acting on the bypass valve increases which results in the opening of the bypass valve. The fluid flow or the oil flows through the bypass valve into the cavity and subsequently through the protection filter stage.

By way of this it is made possible to supply a wind energy plant with filtered lubricating oil even during the start-up of the plant. When the oil heats up during the operation and subsequently circulates in the wind energy plant in the warm state, a greater part of the fluid flow is able to flow through the main filter stage. This results in a pressure drop on the respective bypass valve, which results in the closing of the bypass valve. The heated fluid flow substantially flows through the main filter stage and subsequently the protection filter stage, wherein minor parts of the fluid flow can also flow through the fine filter stage. With the oil or the fluid flow in the hot state, the fluid flow flows through the fine filter stage and the main filter stage simultaneously and subsequently through the protection filter stage, wherein the demanded degree of cleanliness of the fluid flow is achieved through the main filter stage and the fine filter stage. On the protection filter stage a cleaning of the fluid flow takes place substantially only in particular when the fluid flow in the contaminated state flows through the bypass valve and subsequently through the protection filter stage. The fluid flow is particularly thoroughly freed of contaminations by the fine filter stage while through the main filter stage and the bypass valve too great a pressure drop of the fluid flow on the filter element is prevented. It is conceivable that at least one bypass valve is embodied in the manner of a pressure activation valve. When a defined pressure is built up by the fluid flow on the bypass valve, the bypass valve opens. When the defined pressure on the bypass valve is undershot, the bypass valve closes. It is conceivable that the fine filter body and the main filter body comprise a filter material which comprises glass fibres and that the protection filter body comprises a wire fabric. It is possible, furthermore, that on the first end plate fixing lugs are arranged. The filter housing can comprise a cover for closing the filter housing. The cover can comprise receiving openings formed complementarily to the fixing lugs, in which the fixing lugs engage, wherein the filter element is centred by the fixing lugs concentrically in the filter housing, when the cover is arranged on the filter housing or when the filter housing is in the closed state. The fixing lugs project axially from the first end plate, wherein it is conceivable that the fixing lugs and/or the first end plate are produced by means of injection moulding.

The filter element introduced here can be replaceably inserted as replaceable unit in a filter housing of a filter device which serves for filtering the fluid flow.

Preferred is an embodiment, in which at least one of the filter bodies, i.e. the fine filter body and/or the main filter body and/or the protection filter body are configured as ring filler body, which during the operation of a filter device equipped with the filter element is radially flowed through by the fluid flow to be filtered in order to solve the respective filtration object. Such ring filter bodies that can be radially flowed through are characterized by a relatively small space requirement with relatively large cross section that can be flowed through and thus by a comparatively low counter-pressure. Particularly advantageous is an embodiment in which at least the protection filter body is configured as ring filter body, as a result of which it can be relatively easily accommodated in the interior space or cavity of the filter element enclosed by the fine filter body and by the main filter body. A version is optimal in which all three filter bodies are each configured as ring filter body.

For achieving a particularly large filtration surface, a pleated filter material is preferentially used for the respective filter body. In a configuration as ring filter, the filter material is then pleated star-shaped. This applies to the fine filter body and/or to the main filter body and/or to the protection filter body, preferably at least to the fine filter body and/or the main filter body.

According to a second solution according to the invention it is provided that at least the fine filter body is designed for absorbing water and/or for adsorbing oil ageing products from the fluid flow. In addition to the fine filter body, the main filter body can also be designed for absorbing water and/or for adsorbing oil ageing products from the fluid flow. It is practical to reduce the content of water in the oil to a minimum. If water is present in the oil, steam bubbles can develop during a pressure drop which implode during a pressure increase. Furthermore, water acts as a kind of catalyst and accelerates the tendency of the oil to oxidize. This creates long-chain insoluble oil ageing product deposits such as for example resins, sludge or varnish. This results in an increased wear and maintenance expenditure for example of a wind energy plant in which the oil circulates. Through the development of oil ageing products, the ability of the oil of serving as coolant is reduced. Accordingly it is particularly advantageous when the fine filter body and if required the main filter body is/are designed both for absorbing water and also for absorbing oil ageing products. The two solutions according to the invention introduced here can be realized both separately, i.e. independently of one another, and also jointly, i.e. cumulatively.

According to an advantageous embodiment it can be provided that the fine filter body and/or the main filter body contains a superabsorber for absorbing water. A superabsorber is a plastic, generally a polymer, which is able to absorb a multiple of its own weight of a polar liquid, i.e. in particular of water. Through the absorption of the liquid or of the water, the superabsorber swells up and forms a hydrogel. In other words, the fine filter body or the main filter body can contain a super-absorbent, i.e. water-absorbent polymer which through the absorption of water forms a hydrogel.

Preferably, the fine filter body or the main filter body can comprise at least one water-absorbing layer, which contains the superabsorber or the water-absorbent polymer, in particular as powder or as granulate or as fires. The water absorbing layer extends in particular annularly and coaxially to the remaining fine filter body or main filter body.

Advantageously it can be provided that the water absorbing layer comprises a polyester fleece, which comprises two fleece layers, between which the superabsorber or the water-absorbent polymer is arranged. The polyester fleece can be laminated in order to fix the two layers on one another and thus fix the superabsorber or the water-absorbent polymer between the layers, i.e. in the polyester fleece.

According to another advantageous embodiment it can be provided that the fine filter body and/or the main filter body comprises a filer layer arrangement for adsorbing oil ageing products, which comprises multiple filter layers, which possess different filter finenesses and which are arranged in the fine filter body or in the main filter body so that the filter fineness increases in the through-flow direction of the filter body. By way of this, the filtration effect in the through-flow direction increases from filter layer to filter layer, which favours the durable adsorption of relatively long-chain oil ageing products without too great a pressure loss being accompanied by this. The filter fineness correlates with the filtration effect, which correlates with the mesh width or pore size, which in turn correlates with the permeability for solid bodies to be filtered out. The smaller the mesh width or pore size, the finer is the filter material and the smaller are the solid bodies that can be retained. The filter layer arrangement or the filter layers of the same extend in particular annularly and coaxially to the remaining fine filter body.

Practically, the filter layer arrangement can comprise at least two filter layers, namely a coarse filter layer and a fine filter layer, which are arranged in the through-flow direction of the fine filter body so that first the coarse filter layer and then the fine filter layer are flowed through. Advantageously, the filter layer arrangement can comprise at least three filter layers, namely a coarse filter layer, a medium filter layer and a fine filter layer, which in the through-flow direction of the fine filter body are arranged so that first the coarse filter layer, then the medium filter layer and finally the fine filter layer are flowed through.

Advantageously, the respective filter layer of the filter layer arrangement can be formed by a glass fibre fabric. The glass fibre fabrics employed in the different filter layers differ from one another by different mesh widths or permeabilities.

Particularly advantageous is an embodiment in which at least one filter layer of the filter layer arrangement contains the superabsorber or is formed by a water absorbing layer containing the superabsorber. By way of this, the filter layer arrangement is given an additional function, namely as water absorber. Alternatively, the water absorbing layer can be provided additionally to the filter layer arrangement, downstream or preferably upstream thereof.

The fine filter body or the main filter body comprises a filter material which can be constructed in multiple layers so that it can comprise the aforementioned water absorbing layer and/or the aforementioned filter layer arrangement. In addition, further layers can be provided such as for example one or more wire layers for stabilising filter material and/or one or more plastic layers for protecting glass fibre layers. The filter material can be pleated star-shaped in order to form the annular filter body.

Practically, the main filter body can also comprise a filter later arrangement for adsorbing oil ageing products which can be configured quasi like the filter layer arrangement of the fine filter body described above, wherein however the filtration effect in the case of the fine filter body is designed smaller or finer. Additionally or alternatively, the main filter body can likewise comprise such a water-absorbing layer which can likewise be provided for the fine filter body above. In the main filter body, ultimately more volume for more superabsorber is available so that altogether more water can be absorbed.

It is obviously conceivable that on the intermediate plate at least two radially projecting spacer elements that are spaced apart from one another in the circumferential direction and distributed over the circumference of the intermediate plate are formed, by way of which the filter element, during the changing of the filter element, is supported on the filter housing and that at the same time the fine filter body is formed for absorbing water and oil ageing products out of the fluid flow.

A possible embodiment proposes that the fine filter body has a filter fineness of 3 μm+/−1 μm, the main filter body a filter fineness of 10 μm+/−3 μm and the protection filter body a filter fineness of 50 μm+/−10 μm. In the present context, the filter fineness is defined such that 99.5% of particles with a particular size of the respective fineness are filtered out of the fluid flow. This means for example that a filter element, whose filter fineness amounts to 10 μm, can filter 99.5% of particles with a particle size of at least 10 μm out of the fluid flow.

Practically it can be provided that the spacer elements are formed of axially and radially extending ribs. This is advantageous since an intermediate plate with axially and radially extending ribs can be produced relatively cost-effectively and since the axially and radially extending ribs make it possible that the fluid flow can flow through between the ribs. The ribs constitute only a minor flow resistance for the fluid flow as a result of which an undesirable pressure drop on the ribs is largely avoided.

In a further configuration of the invention it can be provided that the filter element comprises a second end plate which comprises a central outlet opening. Here, the protective filter body is arranged in the region of the second end plate so that the fluid flow can flow out of the cavity only through the protective filter body to the outlet opening. By way of this it is substantially prevented that the fluid flow from the cavity can flow out of the filter element without at least partly flowing through the protection filter body beforehand. This is advantageous since because of this the filtration performance of the filter element is improved. The contaminated fluid flow that has flowed through the at least one bypass valve flows through the protection filter body and leaves the filter element in the filtered state through the outlet opening of the second end plate.

In another embodiment it can be provided that the protection filter body comprises an open end plate and a closed end plate, wherein the protection filter body via its open end plate is radially and tightly supported on the fine filter body or on the main filter body in the region of the second end plate. By way of this it is largely prevented that the fluid flow between the fine filter body or the main filter body and the protection filter body or the main filter body and the protection filter body flows past the open end plate. In the region of the second end plate, the fluid flow is diverted by the open end plate so that the fluid flow flows through the protection filter body and in the process is freed of the coarsest contaminations. Obviously it is possible that parts of the fluid flow flow through the protection filter body even before that. The fluid flow flows through the open end plate of the protection filter body and subsequently leaves the filter element through the central outlet opening of the second end plate.

According to a further advantageous embodiment it can be provided that the protection filter body, on its closed end plate, comprises radially projecting support elements that are arranged distributed in the circumferential direction and spaced apart from one another. Here, the protection filter body is radially supported on the fine filter body or on the main filter body or on the intermediate plate via the support elements. Because of this, the protection filter body is centred concentrically in the cavity. This is advantageous since because of this a uniform flow through the protection filter body is made possible. The fluid flow can flow past the closed end plate between two adjacent support elements. Here it is practical that the support elements are embodied so that the flow resistance to the fluid flow put up by the support elements is as low as possible.

A filter element of the type described above can be arranged in a substantially cylindrical filter housing, wherein between an inner wall of the filter housing and the filter element an annular space extending along a longitudinal centre axis of the filter housing is formed. The filter element is radially supported on the filter housing via the spacer elements. Furthermore, the filter element is centred concentrically in the filter housing by the spacer elements in such a manner that the longitudinal centre axis of the filter element runs substantially parallel to the inner wall of the filter housing or parallel to the longitudinal centre axis of the filter housing, as a result of which the annular space always has the same diameter. This is advantageous since because of this a uniform filtration of the fluid flow is made possible.

A filter device having at least one filter element of the type described above, which is arranged in a substantially cylindrical filter housing, is employed preferentially in a wind energy plant for filtering lubricating oil.

Further important features and advantages of the invention are obtained from the subclaims, from the drawings and from the associated figure description by way of the drawings.

It is to be understood that the features mentioned above and still to be explained in the following cannot only be used in the respective combination stated but also in other combinations or by themselves without leaving the scope of the present invention.

Preferred exemplary embodiments of the invention are shown in the drawings and are explained in more detail in the following description, wherein same reference numbers relate to same or similar or functionally same components.

### BRIEF DESCRIPTION OF DRAWINGS

It shows, in each case schematically:

FIG. 1 an isometric view of a filter element according to the invention,

FIG. 2 a plan view of the filter element according to the invention,

FIG. 3 a partly sectioned lateral view of the filter element according to the invention,

FIG. 4 a greatly simplified sectional view of a filter material,

FIG. 5 a sectional view as in FIG. 4, however with another embodiment of the filter material.

### DETAILED DESCRIPTION

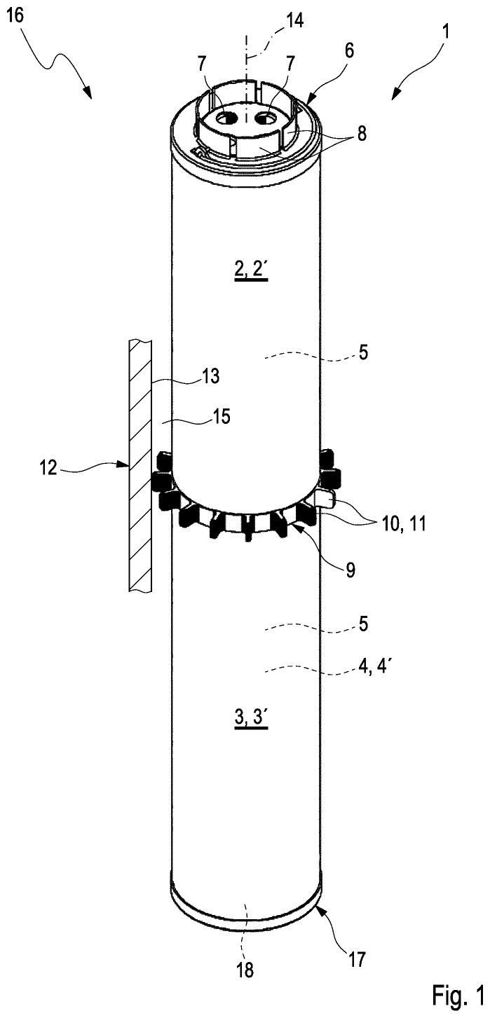

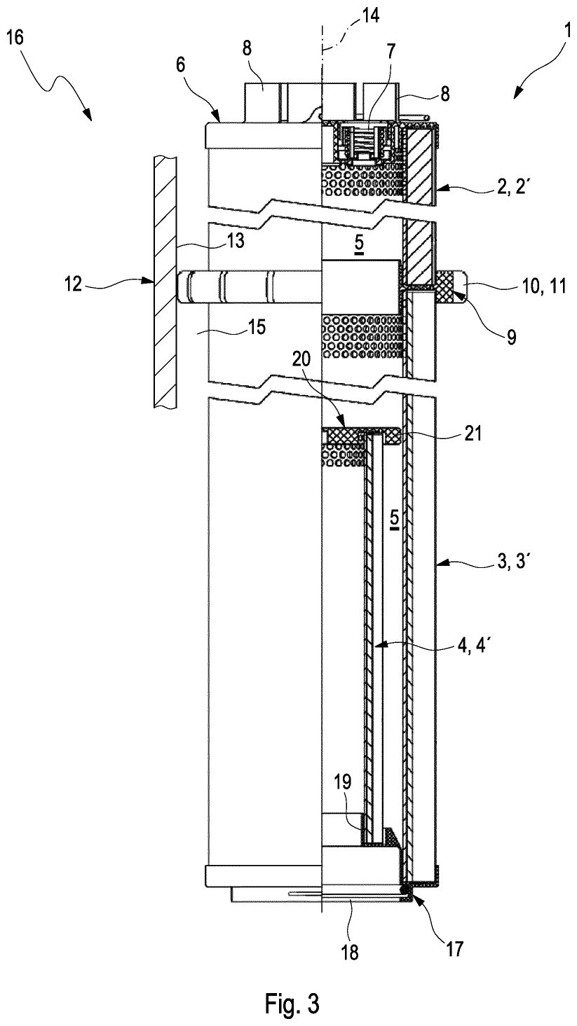

As illustrated in FIG. 1, a filter element 1 designed cylindrically and in three stages for filtering a fluid flow, in particular for filtering lubricating oil, comprises a cylindrical fine filter body 2, which forms a fine filter stage 2′, a cylindrical main filter body 3, which forms a main filter stage 3′, and a cylindrical protection filter body 4, which forms a protection filter stage 4′. Here, the fine filter body 2 and the main filter body 3 axially follow one another and enclose a cavity 5 only shown in FIG. 3, so that the fine filter stage 2′ and the main filter stage 3′ are arranged fluidically parallel. The protection filter 4 which is likewise only shown in FIG. 3 is arranged in this cavity 5 so that the protection filter stage 4′ is arranged fluidically downstream of the fine filter stage 2′ and the main filter stage 3′. Here, the protection filter body 4 in FIGS. 1 and 3 is arranged in the region of the main filter body 3. It is likewise conceivable that the protection filter body 4 is arranged in the region of the fine filter body 2.

In the preferred embodiment shown here, all three filter bodies, i.e. the fine filter body 2, the main filter body 3 and the protection filter body 4 are each configured as ring filter body, so that the respective annular filter body 2, 3, 4 during the operation of a filter device equipped with the filter element 1 is radially flowed through by the fluid flow to be filtered in order to solve the respective filtration object. Such ring filter bodies that can be radially flowed through are characterized by a relatively low space requirement with relatively large through-flow cross section and thus by a comparatively low counter-pressure.

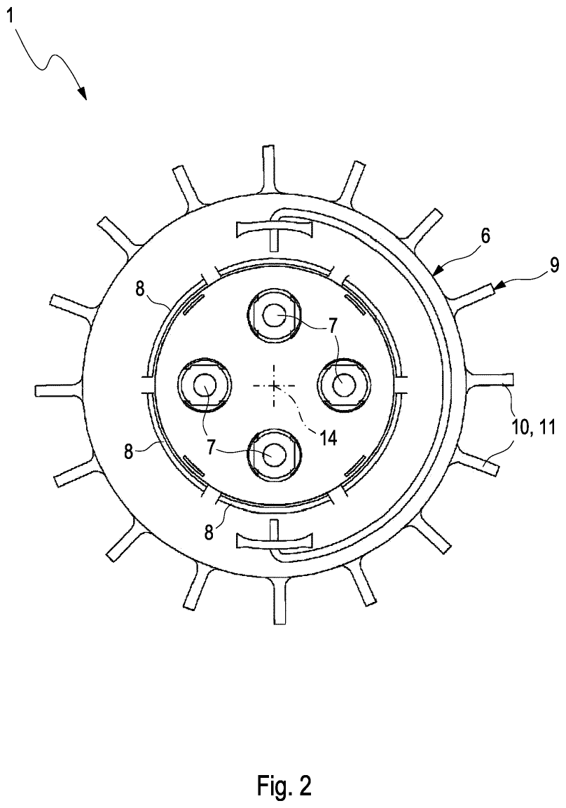

The filter element 1, furthermore, comprises a first end plate 6 on which at least one bypass valve 7 for bypassing the fine filter stage 2′ and the main filter stage 3′ is formed. The number of the bypass valves shown in FIGS. 1 to 3 is merely intended to be exemplary. It is conceivable that on the first end plate 6 fixing lugs 8 are formed.

As illustrated in FIGS. 1 and 3, the filter element 1 comprises an intermediate plate 9, by way of which the fine filter body 2 is axially connected to the main filter body 3. On the intermediate plate 9, radially projecting spacer elements 10 which are spaced apart from one another in the circumferential direction and distributed over the circumference of the intermediate plate 9 are formed. The number of the spacer elements 10 shown in FIGS. 1 to 3 should merely be seen as being exemplary. It is conceivable that the spacer elements 10 are formed of axially and radially extending ribs 11. Spacer elements 10 having a different geometrical shape remain within the scope of the present invention.

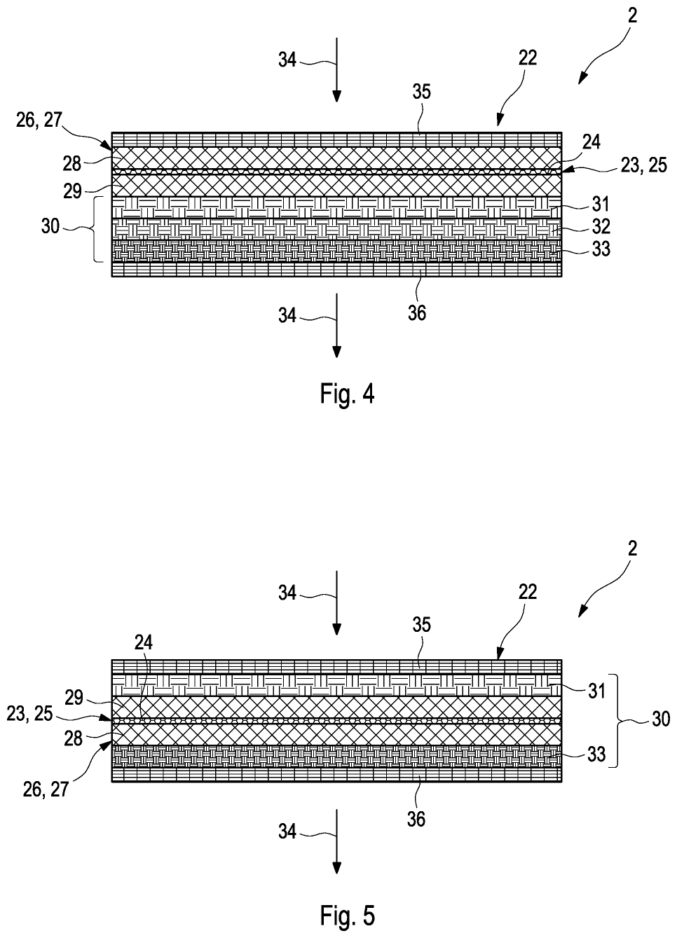

The fine filter body 2 can have a filter fineness of 3 μm+/−1 μm, the main filter body 3 can have a filter fineness of 10 μm+/−3 μm and the protection filter body 4 can have a filter fineness of 50 μm+/−10 μm. Furthermore, the fine filter body 2 can be formed for absorbing water and/or oil ageing products from the fluid flow. This will still be explained in more detail further down below in the connection with FIGS. 4 and 5.

The filter element 1 is arranged in a substantially cylindrical filter housing 12 in such a manner that between an inner wall 13 of the filter housing 12 and the filter element 1 an annular space 15 extending along a longitudinal centre axis 14 of the filter housing 12 is formed. Here, the filter element 1 is radially supported on the filter housing 12 via the spacer elements 10 formed on the intermediate plate 9. The filter housing 12, the inner wall 13 and the annular space 15 are schematically illustrated only in FIGS. 1 and 3.

According to FIGS. 1 and 3, the filter element 1 comprises a second end plate 17 in which a central outlet opening 18 is formed. The protection filter body 4 is arranged in the region of the second end plate 17 so that the fluid flow out of the cavity 5 can only flow through the protection filter body 4 to the outlet opening 18.

As illustrated in FIG. 3, the protection filter body 4 comprises an open end plate 19 and a closed end plate 20. Here, the protection filter body 4 is radially and tightly supported in the region of the second end disc 17 on the fine filter body 2 or on the main filter body 3 via its open end plate 19. It is conceivable, furthermore, that the protection filter body 4 on its closed end plate 20 comprises radially projecting support elements 21 which are arranged distributed in the circumferential direction and spaced apart from one another. Here, the protection filter body 4 is radially supported on the fine filter body 2 or on the main filter body 3 or on the intermediate blade 9 via the support elements 21.

A filter device 16 having the filter housing 12 and having at least one filter element 1 of the type described above is preferentially employed in a wind energy plant for filtering lubricating oil.

According to FIGS. 4 and 5, the main filter body 2 can comprise a filter material 22 of which in FIGS. 4 and 5 only a small part each is shown as sectional view. In an annular fine filter body 2, the filter material 22 can likewise extend annularly. Preferably, the filter material 22 is additionally pleated so that it extends star-shaped in the annular fine filter body 2.

According to an advantageous embodiment it can now be provided that the fine filter body 2 for absorbing water contains a superabsorber 23. Such a superabsorber 23 is a plastic, generally a polymer 24, which is able to absorb a multiple of its own weight of a polar liquid, i.e. in particular water. Through the absorption of the liquid or of the water, the superabsorber 23 swells up and forms a hydrogel 25. In other words, the fine filter body 2 can contain a super-absorbent, i.e. water-absorbent polymer 24 which through the absorption of water forms a hydrogel 25.

Preferably, the fine filter body 2 for this purpose can comprise at least one water-absorbing layer 26 in the filter material 22, which contains the superabsorber 23 or the water-absorbent polymer 24. The water-absorbing layer 26 extends in particular annularly and coaxially to the remaining filter body 2. Advantageously it can now be provided that the water-absorbing layer 26 comprises a polyester fleece 27 or is formed by such, which comprises two fleece layers 28, 29, between which the superabsorber 23 or the water-absorbent polymer 24 is arranged. The polyester fleece 27 can be laminated in order to fix the two layers 28, 29 to one another and thus fix the superabsorber 23 or the water-absorbent polymer 24 between the layers 28, 29, i.e. in the polyester fleece 27.

Additionally or alternatively it can now be provided that the fine filter body 2 in the filter material 22 comprises a filter layer arrangement 30 for adsorbing of oil ageing products which comprises multiple filter layers 31, 32, 33, which have different filter finenesses and which are arranged in the fine filter body 2 so that the filter fineness increases in the through-flow direction 34 of the fine filter body 2 indicated by arrows. By way of this, the filtration effect increases in the through-flow direction 34 from filter layer 31, 32, 33 to filter layer 31, 32, 33. The filter layers 31, 32, 33 and thus the filter layer arrangement 30 extend in particular annularly and coaxially to the remaining fine filter body 2.

Practically, the filter layer arrangement 30 can comprise at least two, three or more filter layers 31, 32, 33. In the example of FIG. 4, exactly three filter layers are provided in the filter layer arrangement 30, namely a coarse filter layer 31, a medium filter layer 32 and a fine filter layer 33, which are arranged in the through-flow direction 34 of the fine filter body 2 so that first the coarse filter layer 31, then the medium filter layer 32 and finally the fine filter layer 33 are flowed through. In the embodiment shown in FIG. 5, by contrast exactly two filter layers are arranged in the filter layer arrangement 30, namely a coarse filter layer 31 and a fine filter layer 33, which in the through-flow direction 34 of the fine filter body 2 are arranged so that first the coarse filter layer 31 and thereafter the fine filter layer 33 are flowed through. As mentioned further up, the fine filter body 2 can have a filter fineness of 3 μm+/−1 μm. With the progressive filtration effect introduced here, this filter fineness of the multi-layered fine filter body 2 is ultimately defined by the layer with the smallest filter fineness. This means in this example that the fine filter layer 33 has a filter fineness of 3 μm+/−1 μm, while the medium filter layer 32 and the coarse filter layer 31 are coarser. For example, the medium filter layer 32 can have a filter fineness of 6 μm+/−2 μm or more and the coarse filter layer 31 can have a filter fineness of 9 μm+/−3 μm or more. Advantageously, the respective filter layer 31, 32, 33 of the filter layer arrangement 30 can be formed by a glass fibre fabric or glass fibre fleece. The glass fibre fabrics or glass fibre fleeces that are employed in the various filter layers 31, 32, 33 differ by different mesh widths or permeabilities or pore sizes from one another. Different fibre lengths and/or fibre thicknesses are also conceivable.

In the example of FIG. 4, the water-absorbing layer 26 is provided additionally to the filter layer arrangement 30. In FIG. 4, the water-absorbing layer 26 is arranged, regarding the through-flow direction 34, upstream of the filter layer arrangement 30. Because of this, the superabsorber 23 and during the operation the hydrogel 25 are better retained in the filter material 22.

In the embodiment shown in FIG. 5, the superabsorber 23 is integrated in the filter layer arrangement 30. For this purpose, the water-absorbing layer 26 is arranged between two of the filter layers 31, 32, 33 of the filter layer arrangement 30. In the example of FIG. 5, the water-absorbing layer 26 forms the medium layer between the coarse filter layer 31 and the fine filter layer 33. Because of this, the filter layer arrangement 30 is given an additional function, namely as water absorber.

Thus, the fine filter body 2 comprises a filter material 22 which is constructed in multiple layers so that it can comprise the aforementioned water-absorbing layer 26 and/or the aforementioned filter layer arrangement 30. In addition, further layers can be provided such as for example one or more wire layers for stabilising the filter material 22. In the example of FIGS. 4 and 5, the filter material 22 is stabilised and protected through a wire mesh layer 35 on the inflow side and through a wire mesh layer 36 on the outflow side. At least one further plastic fleece layer which is not shown can be provided for example for protecting the glass fibre layers.

1. A filter element for filtering a fluid flow, comprising:
a cylindrical fine filter body that forms a fine filter stage, a cylindrical main filter body that forms a main filter stage, and a cylindrical protection filter body that forms a protection filter stage,
wherein the fine filter body and the main filter body follow one another axially and enclose a cavity so that the fine filter stage and the main filter stage are arranged fluidically parallel,
wherein the protection filter body is arranged in the cavity so that the protection filter stage is fluidically arranged downstream of the fine filter stage and the main filter stage,
a first end plate, on which at least one bypass valve for bypassing the fine filter stage and the main filter stage is disposed,
an intermediate plate that axially connects the fine filter body to the main filter body, and
at least two radially projecting spacer elements disposed on the intermediate plate spaced apart from one another in a circumferential direction and distributed over a circumference of the intermediate plate.

2. The filter element according to claim 1, wherein the fine filter body is configured as a ring filter body that can be radially flowed through by the fluid flow.

3. The filter element according to claim 1, wherein the main filter body is configured as a ring filter body that can be radially flowed through by the fluid flow.

4. The filter element according to claim 1, wherein the protection filter body is configured as a ring filter body that can be radially flowed through by the fluid flow.

5. The filter element according to claim 1, wherein the fine filter body, the main filter body and the protection filter body are each configured as a ring filter body which can each be radially flowed through by the fluid flow.

6. The filter element according to claim 1, wherein the fine filter body is configured for at least one of absorbing water for and adsorbing oil ageing products from the fluid flow.

7. The filter element according to claim 6, wherein the fine filter body contains a superabsorber for absorbing water.

8. The filter element according to claim 7, wherein the fine filter body contains at least one water-absorbing layer, which contains the superabsorber.

9. The filter element according to claim 8, wherein the at least one water-absorbing layer comprises a polyester fleece, the polyester fleece including two fleece layers between which the superabsorber is arranged.

10. The filter element according to claim 6, wherein the fine filter body is configured for adsorbing oil ageing products and comprises a filter layer arrangement that includes multiple filter layers each having different filter finenesses and which are arranged in the fine filter body so that the filter fineness increases in the through-flow direction of the fine filter body.

11. The filter element according to claim 10, wherein one of:
the filter layer arrangement comprises at least two filter layers that include a coarse filter layer and a fine filter layer, which in the through-flow direction of the fine filter body are arranged so that first the coarse filter layer and then the fine filter layer are flowed through, and
the filter layer arrangement comprises at least three filter layers that include a coarse filter layer, a medium filter layer and a fine filter layer, which in the through-flow direction of the fine filter body are arranged so that first the coarse filter layer, then the medium filter layer and then the fine filter layer are flowed through.

12. The filter element according to claim 10, wherein at least one filter layer of the filter layer arrangement is composed of a glass fibre fabric.

13. The filter element according to claim 7, wherein at least one filter layer of the filter layer arrangement contains the superabsorber or is formed through a water-absorbing layer containing the superabsorber.

14. A filter element for filtering a fluid flow, comprising:
a cylindrical fine filter body that forms a fine filter stage, a cylindrical main filter body that forms a main filter stage, and a cylindrical protection filter body that forms a protection filter stage,
wherein the fine filter body and the main filter body follow one another axially and enclose a cavity, so that the fine filter stage and the main filter stage are arranged fluidically parallel,
wherein the protection filter body is arranged in the cavity so that the protection filter stage is fluidically arranged downstream of the fine filter stage and the main filter stage,
a first end plate including at least one bypass valve for bypassing the fine filter stage and the main filter stage,
an intermediate plate, structured and arranged to axially connect the fine filter body to the main filter body,
wherein the fine filter body is configured for absorbing at least one of water and oil ageing products from the fluid flow.

15. The filter element according to claim 14, further comprising at least two radially projecting spacer elements disposed on the intermediate plate spaced apart from one another in a circumferential direction and distributed over a circumference of the intermediate plate.

16. The filter element according to claim 1, wherein the at least two spacer elements include axially and radially extending ribs.

17. The filter element according to claim 1, wherein:
the fine filter body has a filter fineness of 3 μm+/−1 μm,
the main filter body has a filter fineness of 10 μm+/−3 μm,
the protection filter body has a filter fineness of 50 μm+/−10 μm.

18. The filter element according to claim 1, further comprising:
a second end plate having a central outlet opening,
wherein the protection filter element is arranged in a region of the second end plate so that the fluid flow can flow out of the cavity to the outlet opening only through the protection filter body.

19. The filter element according to claim 18, wherein:
the protection filter body comprises an open plate and a closed end plate, and
the protection filter body is radially and tightly supported via the open end plate in the region of the second end plate on the fine filter body or on the main filter body.

20. The filter body according to claim 19, wherein the protection filter body on the closed end plate comprises radially projecting support elements that are arranged distributed in the circumferential direction and spaced apart from one another, via which the protection filter body is radially supported on one of the fine filter body, the main filter body, and the intermediate plate.

21. A filter device for filtering lubricating oil, comprising:
at least one filter element, the at least one filter element including:
a cylindrical fine filter body that forms a fine filter stage, a cylindrical main filter body that forms a main filter stage, and a cylindrical protection filter body that forms a protection filter stage;
wherein the fine filter body and the main filter body follow one another axially and enclose a cavity so that the fine filter stage and the main filter stage are arranged fluidically parallel;
wherein the protection filter body is arranged in the cavity so that the protection filter stage is fluidically arranged downstream of the fine filter stage and the main filter stage;
a first end plate, on which at least one bypass valve for bypassing the fine filter stage and the main filter stage is disposed;
an intermediate plate that axially connects the fine filter body to the main filter body; and
at least two radially projecting spacer elements disposed on the intermediate plate spaced apart from one another in a circumferential direction and distributed over a circumference of the intermediate plate;
at least one substantially cylindrical filter housing, in which the at least one filter element is arranged,
wherein an annular space is disposed between an inner wall of the filter housing and the at least one filter element that extends along a longitudinal centre axis of the filter housing.

22. The filter device according to claim 21, wherein the at least one filter element radially supports itself on the filter housing via the at least two radially projecting spacer elements.
